(19) United States
(12) Patent Application Publication
(10) Pub. No.: US 2024/0031785 A1
(43) Pub. Date: Jan. 25, 2024

(54) Electronics Module and Wearable Assembly

(71) Applicant: Prevayl Innovations Limited, Manchester, Greater Manchester (GB)

(72) Inventor: Michael John Lynch, Chesire (GB)

(21) Appl. No.: 18/042,329

(22) PCT Filed: Aug. 23, 2021
(86) PCT No.: PCT/GB2021/052192

§ 371 Date: Feb. 21, 2023

(30) Foreign Application Priority Data
Aug. 25, 2020 (GB) 2013243.7

(51) Int. Cl. H04W 4/38; H04W 4/02; H04W 76/10

(52) U.S. Cl. CPC H04W 4/38; H04W 4/02; H04W 76/10

(57) ABSTRACT

The electronics module (100) comprises a memory (101) operable to store sensor data obtained from a sensor of or in communication with the electronics module (100). A communicator (103) is operable to transmit sensor data. A processor (105) is operable to retrieve a plurality of historic sensor data from the memory (101), and control the communicator (103) to wirelessly transmit the plurality of samples of historic sensor data in response to the processor (105) determining to transmit historic sensor data. Determining to transmit historic sensor data comprises the processor (105) determining that an external device (200) has been brought into proximity with the electronics module (100) and/or comprises the processor (105) determining that an abnormal condition is present in sensor data obtained from the sensor.

### BACKGROUND

Wearable articles can be designed to interface with a user of the article, and to determine information such as the user's heart rate, rate of respiration, activity level, and body positioning. Such properties can be measured with a sensor assembly that includes a sensor for signal transduction and/or microprocessors for analysis. The articles include electrically conductive pathways to allow for signal transmission between an electronics module for processing and communication and sensing components of the article. The wearable articles may be garments. Such garments are commonly referred to as ‘smart clothing’ and may also be referred to as ‘biosensing garments’ if they measure biosignals.

It is desirable to overcome at least some of the problems associated with the prior art, whether explicitly discussed herein or otherwise.

### SUMMARY

According to the present disclosure there is provided an electronics module, wearable assembly, system, and method as set forth in the appended claims. Other features of the invention will be apparent from the dependent claims, and the description which follows.

According to a first aspect of the disclosure, there is provided electronics module for a wearable article. The electronics module comprises a memory operable to store sensor data obtained from a sensor of or in communication with the electronics module. The electronics module comprises a communicator operable to transmit sensor data. The electronics module comprises a processor operable to retrieve a plurality of samples of historic sensor data from the memory, and control the communicator to wirelessly transmit the plurality of samples of historic sensor data in response to the processor determining to transmit historic sensor data.

Advantageously, the disclosure provides a mechanism for triggering the electronics module to offload historic sensor data to an external device. This mechanism enables the electronics module to perform a data dump of historic sensor data. The historic sensor data is useable by the external device to perform an assessment regarding the person wearing the wearable article. The determining to transmit historic sensor data comprises the processor determining that an external device has been brought into proximity with the electronics module. Advantageously, the simple act of brining the electronics module into proximity with the electronics module triggers the electronics module to retrieve and transmit the historic sensor data. This provides an intuitive and user-friendly process for triggering the transmission of historic sensor data. This process also helps ensure that the historic sensor data arrives at the correct external device. For example, information exchanged as the electronics module and the external device are in proximity with one another can cause the electronics module and the external device to configure their communication circuitry such that they may communicate with one another.

The transmitted historic sensor data may be a subset of the sensor data stored on the memory. The transmitted historic sensor data may relate to a predetermined time window of sensor data stored on the memory. The transmitted historic sensor data may comprise all of the sensor data stored on the memory. The transmitted historic sensor data may comprise all of the sensor data stored on the memory for a particular sensor.

The processor may be operable to control the communicator to broadcast the plurality of samples of historic sensor data. The controller may therefore transmit the historic sensor data over a one-to-many communication protocol. The processor may be operable to control the communicator to broadcast the plurality of samples of historic sensor data over an unsecured wireless communication channel. The external device may configure its communication circuitry such that the external device is able to receive the historic sensor data over the communication channel.

Advantageously, the electronics module may act as a beacon to broadcast historic sensor data. This provides a fast mechanism for offloading data to the external device as the electronics module and external device are not required to initially pair with one another. This is particularly beneficial in time critical situations where it is desirable to offload the historic sensor data as quickly as possible.

The processor may be operable to control the communicator to wireless pair with the external device and, once paired, transmit the plurality of samples of historic sensor data to the external device. The processor may be operable to control the communicator to transmit the plurality of samples of historic sensor data over a one-to-one communication protocol.

Advantageously, the electronics module and the external device may pair prior to the transmission of the historic sensor data. This provides a secure mechanism for offloading data to the external device. This is particularly beneficial in where it is desirable to restrict who has access to the historic sensor data.

The communicator may comprise a first antenna. The processor may be operable to determine that an external device is brought into proximity with the electronics module as a result of a current being induced in the first antenna.

The communicator may comprise a second antenna. The second antenna may be controlled by the controller to transmit the plurality of samples of historic sensor data.

The electronics module may comprise a motion sensor. The memory may be operable to store motion sensor data obtained from the motion sensor. The processor may be operable to retrieve a plurality of samples of historic motion sensor data from the memory. The processor may be operable to control the communicator to wirelessly transmit the plurality of samples of historic motion sensor data. The motion sensor may be arranged to detect motion imparted to the electronics module as a result of the external device being brought into proximity with the electronics module. The processor may be operable to determine that the external device has been brought into proximity with the electronics module as a result of motion sensor data sensed by the motion sensor.

The communicator may be arranged to receive a request from the external device for historic sensor data. The processor may be operable to control the communicator to wirelessly transmit the plurality of samples of historic sensor data in response to receiving the request. The request may specify a time range for the historic sensor data, an amount of historic sensor data to be transmitted and/or the type of sensor that the historic sensor data should relate to.

The communicator may be arranged to receive the request while the external device is in proximity with the electronics module. The communicator may be arranged to receive the request over a magnetic induction-based proximity communication protocol.

The request may comprise authorisation information for the external device. The processor may be arranged to determine from the authorisation information whether the external device is authorised to access the sensor data. In response to determining that the external device is authorised, the processor may be operable to control the communicator to wirelessly transmit the plurality of samples of historic sensor data.

The memory may be operable to store sensor data obtained from a plurality of sensors of or in communication with the electronics module. The processor may be operable to retrieve a plurality of samples of historic sensor data from the memory, the plurality of samples of historic sensor data comprising sensor data obtained from the plurality of sensors or a subset thereof.

The transmitted sensor data may be raw sensor data. The transmitted sensor data may be processed sensor data. Ideally, a minimal amount of processing is performed on the sensor data, such as limited pre-processing.

The plurality of samples of historic sensor data may cover a time period of at least 0.5 seconds preceding the determination to transmit sensor data by the processor. The time period may be at least 1 second. The time period may be at least 5 seconds. The time period may be at least 10 seconds. The time period may be at least 30 seconds. The time period may be at least 1 minute. The time period may be at least 2 minutes. The time period may be at least 5 minutes. The time period may be at least 10 minutes. The time period may be at least 20 minutes.

The plurality of samples of historic sensor data may cover a time period of less than 2 hours preceding the determination to transmit sensor data by the processor. The time period may be less than 60 minutes. The time period may be less than 30 minutes. The time period may be less than 20 minutes. The time period may be less than 10 minutes. The time period may be less than 5 minutes. The time period may be less than 1 minute. The time period may be less than 30 seconds. The time period may be less than 10 seconds.

It will be appreciated that the number of samples of historic sensor data transmitted is limited primarily by the size of the memory. A larger memory can store a larger number of samples of historic sensor data and thus represent a larger time period. The memory may store one or more hours of historic sensor data and may even store 12 hours or 24 hours of historic sensor data.

The plurality of samples of historic sensor data may cover a time period that immediately precedes the determination to transmit sensor data by the processor. The time period may a period that immediately precedes the determination, by the electronics module, of an anomaly/abnormal condition in the sensor data, e.g. the time period preceding the detection of a fall, impact, or other medically significant event for the person wearing the wearable article. The time period may be specified by the external device during an initial communication with the electronics module.

The electronics module may comprise an input unit arranged to detect the external device being brought into proximity with the electronics module. The input unit may comprise an antenna. The input unit may detect the external device being brought into proximity with the electronics module as a result of a current being induced in the antenna. The external device may comprise an active antenna to induce the current in the antenna of the electronics module.

The input unit may comprise a sensor such as a motion or proximity sensor. The motion sensor may be arranged to detect the external device being brought into proximity with the electronics module. That is, the sensor may be able to detect a “tap” input caused by the external device being tapped against the electronics module or a pocket or other holder in which the electronics module is located. The sensor is not required to be a motion sensor. Other forms of sensor such as capacitive sensors, optical sensors, and ultrasound sensors may be used to detect the external device being brought into proximity with the electronics module. Preferred implementations use motion sensors particularly as motion sensors can utilised for additional tasks such as recognising and classifying motion activities (e.g. running, walking, swimming, cycling) performed by a user wearing the wearable article.

The electronics module may further comprise an interface arranged to communicatively couple with a sensing unit of the wearable article so as to receive a signal from the sensing unit. The interface may comprise a signal coupling mechanism configured, when the electronics module is attached to the wearable article at an electronics module of the wearable article, to couple the electronics module to a sensing unit of the wearable article. The interface may not be required for all aspects of the present disclosure. That is, the sensing units may be contained within the electronics module.

The sensing units may be biosensing units. The sensing units may comprise one or more components of a temperature sensor, a humidity sensor, a motion sensor, an electropotential sensor, an electroimpedance sensor, an optical sensor, and/or an acoustic sensor. Here, “component” means that not all of the components of the sensor may be provided in the wearable article or are required to be provided in the wearable article. The processing logic, power and other functionality may be provided in the electronics module/controller.

Determining to transmit historic sensor data may comprise the processor determining that an abnormal condition is present in sensor data obtained from the sensor.

Advantageously, the electronics module may independently determine to transmit the historic sensor data if an abnormal condition is detected in the sensor data.

The abnormal condition may indicate that a user of the electronics module has undergone a medical emergency.

The abnormal condition may be determined if sensor data indicates that one or more properties of the user are outside of an expected range. The abnormal condition may be determined if sensor data indicates that one or more properties of the user are higher than a predetermined value. The abnormal condition may be determined if sensor data indicates that one or more properties of the user are lower than a predetermined value. For example, the abnormal condition may be determined if the sensor data indicates that the user has an unusually high or low heart rate. The abnormal condition may be determined if the sensor data indicates that the user has undergone a rapid change in acceleration indicative of a collision.

The sensor data may comprise one or more of heart rate data, hydration data, temperature data, and motion data.

The abnormal condition may indicate that a user of the electronics module has fallen. The processor is arranged to determine that the user has fallen from motion sensor data. The abnormal condition may indicate that a user of the electronics module has fallen and remained in a generally horizontal position for more than a predetermined time.

Determining to transmit historic sensor data may comprise the processor determining that a request to transmit historic sensor data has been received by the communicator. Advantageously, the electronics module may determine to transmit historic sensor data if it receives a request to do so. The request may be received from an external device such as a mobile phone or another electronics module.

The processor may be operable to retrieve a plurality of samples of historic sensor data from the memory, control the communicator to wirelessly transmit the plurality of samples of historic sensor data and a request for historic sensor data in response to the processor determining to transmit historic sensor data. The plurality of samples of historic sensor data may be transmitted to a first external device. The request for historic sensor data may be transmitted to a second external device. Advantageously, the electronics module is able to transmit their historic sensor data and trigger another device such as another electronics module to also transmit historic sensor data.

According to a second aspect of the disclosure, there is provided a wearable assembly comprising a wearable article and an electronics module according to the first aspect of the disclosure. The wearable article may form or be part of a garment.

The wearable article may comprise one or more sensing units. The one or more sensing units may be arranged to measure one or more biosignals of a user wearing the wearable article. Here, “biosignal” may refer to any signal in a living being that can be measured and monitored. The term “biosignal” is not limited to electrical signals and can refer to other forms of non-electrical biosignals. The sensing units may be used for measuring one or a combination of bioelectrical, bioimpedance, biochemical, biomechanical, bioacoustics, biooptical or biothermal signals of the user. The bioelectrical measurements include electrocardiograms (ECG), electrogastrograms (EGG), electroencephalograms (EEG), and electromyography (EMG). The bioimpedance measurements include plethysmography (e.g., for respiration), body composition (e.g., hydration, fat, etc.), and electroimpedance tomography (EIT). The biomagnetic measurements include magnetoneurograms (MNG), magnetoencephalography (MEG), magnetogastrogram (MGG), magnetocardiogram (MCG). The biochemical measurements include glucose/lactose measurements which may be performed using chemical analysis of the user's sweat. The biomechanical measurements include blood pressure. The bioacoustics measurements include phonocardiograms (PCG). The biooptical measurements include orthopantomogram (OPG). The biothermal measurements include skin temperature and core body temperature measurements. The sensing units may comprise a radar unit. The wearable article may sense a combination of external signals and biosignals of the user.

According to a third aspect of the disclosure, there is provided a system. The system comprises an electronics module according to the first aspect of the disclosure and an external device. The external device is arranged to receive the plurality of samples of historic sensor data from the electronics module.

According to a fourth aspect of the disclosure, there is provided a method of controlling an electronics module for a wearable article to transmit sensor data. The method comprises storing, by the electronics module, sensor data obtained from a sensor of or in communication with the electronics module. The method comprises determining, by the electronics module, to transmit historic sensor data. In response to determining to transmit historic sensor data: the method comprises retrieving, by the electronics module, a plurality of samples of stored historic sensor data, and wirelessly transmitting, by the electronics module, the plurality of samples of historic sensor data.

The determining may comprise determining that an external device has been brought into proximity with the electronics module.

The determining may comprise determining that an abnormal condition is present in sensor data obtained from the sensor.

The determining may comprise determining that a request for transmitting historic sensor data has been received.

The method may further comprise transmitting, by the electronics module, a request for historic sensor data in response to the processor determining to transmit historic sensor data. The historic sensor data may be transmitted to a first external device. The request for historic sensor data may be transmitted to a second external device. The second external device may be an electronics module.

### BRIEF DESCRIPTION OF THE DRAWINGS

Examples of the present disclosure will now be described with reference to the accompanying drawings, in which:

FIG. 1 shows a schematic diagram for an example system according to aspects of the present disclosure;

FIG. 2 shows a process flow diagram for an example method according to aspects of the present disclosure;

FIG. 3 shows a swim lane diagram for another example method according to aspects of the present disclosure;

FIG. 4 shows a swim lane diagram for another example method according to aspects of the present disclosure;

FIG. 5 shows a schematic diagram for another example system according to aspects of the present disclosure;

FIG. 6 shows a sectional view of an example wearable assembly comprising an electronics module and a wearable article according to aspects of the present disclosure;

FIGS. 7 and 8 show perspective views of an example electronics module according to aspects of the present disclosure;

FIG. 9 shows a view of first surface of a wearable article according to aspects of the present disclosure;

FIG. 10 shows an electronics module positioned on the first surface of the wearable article of FIG. 9;

FIG. 11 shows a view of a second surface of the wearable article of FIG. 9; and

FIG. 12 shows a sectional view of the wearable article of FIG. 9 with the electronics module positioned on the first surface of the wearable article.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise.

“Wearable article” as referred to throughout the present disclosure may refer to any form of article which may be worn by a user such as a smart watch, necklace, bracelet, or glasses. The wearable article may be a textile article. The wearable article may be a garment. The garment may refer to an item of clothing or apparel. The garment may be a top. The top may be a shirt, t-shirt, blouse, sweater, jacket/coat, or vest. The garment may be a dress, brassiere, shorts, pants, arm or leg sleeve, vest, jacket/coat, glove, armband, underwear, headband, hat/cap (e.g. a hardhat), collar, wristband, stocking, sock, or shoe, athletic clothing, personal protecting equipment, swimwear, wetsuit or drysuit

The garment may be a tight-fitting garment. Beneficially, a tight-fitting garment helps ensure that the sensor devices of the garment are held in contact with or in the proximity of a skin surface of the user. The garment may be a compression garment. The garment may be an athletic garment such as an elastomeric athletic garment.

The wearable article may be constructed from a woven or a non-woven material. The wearable article may be constructed from natural fibres, synthetic fibres, or a natural fibre blended with one or more other materials which can be natural or synthetic. The yarn may be cotton. The cotton may be blended with polyester and/or viscose and/or polyamide according to the particular application. Silk may also be used as the natural fibre. Cellulose, wool, hemp, and jute are also natural fibres that may be used in the wearable article. Polyester, polycotton, nylon and viscose are synthetic fibres that may be used in the wearable article.

The following description refers to particular examples of the present disclosure where the wearable article is a garment. It will be appreciated that the present disclosure is not limited to garments and other forms of wearable article are within the scope of the present disclosure as outlined above.

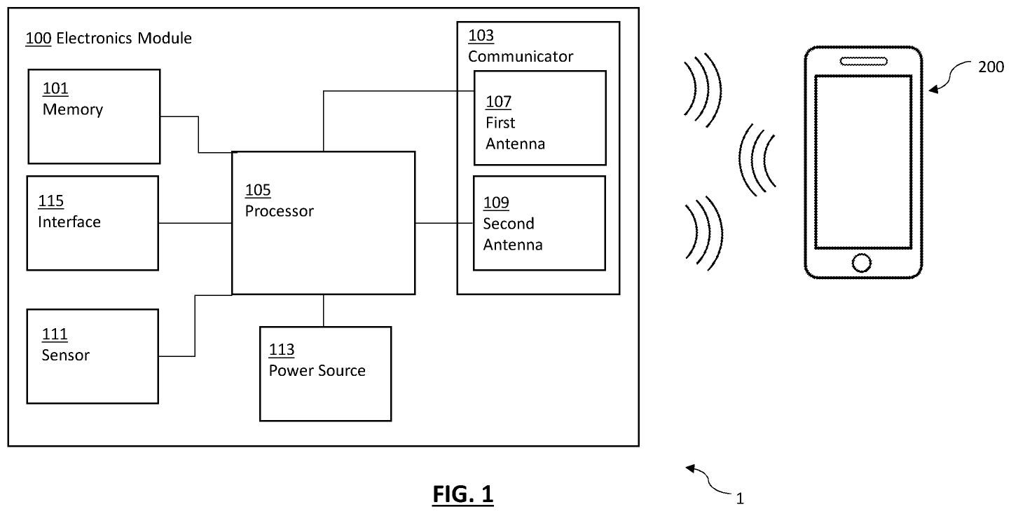

Referring to FIG. 1, there is shown an electronics module 100 and an external device 200 according to aspects of the present disclosure. The electronics module 100 and external device 200 may form a system 1.

The electronics module 100 is arranged to wirelessly communicate data to the external device 200. Various protocols enable wireless communication between the electronics module 100 and the external device 200. Example communication protocols include Bluetooth®, Bluetooth® Low Energy, and a magnetic induction-based communication protocol such as near-field communication (NFC).

The external device 200 may be any form of device that is remote to the electronics module 100. The external device 200 may be any form of user electronic device such as a mobile device, e.g. a mobile phone. The external device 200 may be a tablet computer, another wearable device such as a smart watch. The external device 200 in FIG. 1 is a smartphone.

The electronics module 100 is suitable for use with a wearable article. The electronics module 100 may be an integral component of the wearable article or may be removably coupled to the electronics module 100. The electronics module 100 may be removably mechanically coupled to the wearable article. When coupled to the electronics module 100, the electronics module 100 may be brought into communication with sensing components of the wearable article such as discrete sensors or electrodes.

The electronics module 100 comprises a memory 101. The memory 101 is operable to store sensor data obtained from a sensor of or in communication with the electronics module 100. The memory 101 may comprises a buffer in which the sensor data is temporarily stored. The buffer may be a first-in first-out buffer.

The electronics module 100 comprises a communicator 103 operable to transmit sensor data. The communicator 103 is operable to wirelessly transmit the sensor data over one or more wireless communication protocols.

The electronics module 100 comprises a processor 105.

The processor 105 is communicatively coupled to sensors of or in communication with the electronics module 100 and is arranged to receive the signals from the sensors. The processor 105 is configured to process signals sensed by the sensors and/or control the memory 101 to store sensor data.

The processor 105 is operable to determine to transmit historic sensor data.

In some examples, the processor 105 determining to transmit historic sensor data comprises the processor 105 determining that the external device 200 has been brought into proximity with the electronics module 100. In other words, the processor 105 determines that the external device 200 has been brought into proximity with the electronics module 100 and this triggers the processor 105 to determine to transmit historic sensor data.

Being brought into proximity with the electronics module 100 generally means that the external device 200 is close enough to establish a magnetic induction-based communication with the communicator 103 of the electronics module 100. The external device 200 may be tapped against the electronics module 100 or a fabric layer covering the electronics module 100. Generally, proximity refers to a distance of less than 30 cm, preferably less than 20 cm, preferably less than 10 cm, preferably less than 5 cm.

In response to determining to transmit historic sensor data, the processor 105 is operable to retrieve a plurality of samples of historic sensor data from the memory 101. The processor 105 is then operable to control the communicator 103 to wirelessly transmit the plurality of samples of historic sensor data.

In accordance with the present disclosure, the external device 200 being brought into proximity with the electronics module 100 causes the electronics module 100 to transmit a plurality of samples of historic sensor data. This provides a simple process for enabling the electronics module 100 to bulk transfer historic sensor data to the external device 200. In other words, a user of the external device 200 can obtain a data dump from the electronics module 100 by simply and intuitively bringing the external device 200 into proximity with the electronics module 100.

In an example use case, the electronics module 100 is worn by a player in a football match. During the football match, sensor data obtained by the electronics module 100 may be transmitted to a workstation such that coaching staff may review the performance of the player and identify factors such as whether the player is over tired, dehydrated or at risk of injury. The information displayed at the workstation is typically highly processed sensor data. By this it is meant that a number of processing operations are performed on the sensor data so as to identify trends and other metrics from the sensor data. The information displayed at the workstation typically includes alerts and high-level data representations rather than raw data obtained from the sensors. The information displayed may include scores such as a recovery score or a stress score which are determined by combining multiple values and types of sensor data. The workstation will typically display information for a number of different players, e.g. all of the players in the football team simultaneously. Moreover, the sensor data transmitted to the workstation may have a lower sampling rate than the sampling rate of the sensor. This may be due to constraints on the communication protocol between the electronics module 100 and the workstation, the fact that multiple electronics modules may be communication with the workstation at the same time, and other factors such as reducing battery consumption of the electronics module 100. Generally, this means that not all of the samples of the sensor data stored in the memory 101 are transmitted to the workstation.

A player wearing the electronics module 100 may suffer an injury during the football match. For example, the player may suffer a collision. It would be desirable for the coaching or medical staff to determine the extent of the player's injury so as to make assessments such as whether to allow them to continue to play, to stop playing, or seek medical attention. A particular use case would be to determine whether a player is likely to have suffered a concussion.

While some insights on the player's medical state may be derivable from the workstation in communication with the electronics module 100, it would be desirable for the coaching or medical staff to obtain historic sensor data from the electronics module 100 covering events leading up to and immediately preceding the injury event.

In accordance with the present disclosure, a medical staff member, for example, attending to the player on the pitch may tap their mobile device 200 against the electronics module 100 to cause the electronics module 100 to dump historic sensor data to the mobile device 200. The medical staff member can view this historic sensor data on the mobile device 200 and determine, for example, the G-forces experienced by the player during the collision. The G-forces are determined from accelerometer data obtained from a motion sensor of the electronics module 100. This can be used by the medical staff member to determine whether the player was likely to have suffered a concussion. Beneficially, the present disclosure allows the medical staff member to access this information quickly just by using their mobile phone 200. A pre-registration sequence, for example, may not be required such that any mobile phone 200 running appropriate application software may obtain the data. Equally, a permissions-based procedure may be used so that only authorised users may access the data. A permissions-based procedure is generally preferred as it provides security and prevents the unauthorised transmission of potentially sensitive personal data.

Moreover, as the external device 200 receives the historic sensor data from the electronics module 100 the historic sensor data has been backed up and will not be lost if the electronics module is subsequently damaged or destroyed. For example, during a medical intervention it is typical to cut-off and discard of the clothing worn by the patient which can lead to the electronics module 100 attached to the clothing being damaged or discarded.

The present disclosure is not limited to sports applications and can be used in other applications such as in the monitoring of workers in a factory or construction environment. For example, in an industrial worker scenario, there may be a large number of people equipped with electronics modules that are transmitting data to a central hub. An effective mechanism for quickly obtaining high sample rate historic sensor data from one particular worker would be desirable. The existing communication channels may have insufficient bandwidth for such an exchange of data. The approach of the present disclosure overcomes this problem.

Advantageously, the present disclosure enables the external device 200 to receive the historic sensor data in a raw or unprocessed form, with a minimal amount of processing and filtering, and/or at its original sampling rate such that the original obtained sensor data can be viewed rather than an abstraction of the data. This can enable more accurate or informed medical assessments to be made by the user. The present disclosure also enables the sensor data to be quickly and intuitively obtained and viewed on a device which may be but is not necessarily the workstation in a way that does not require removing the electronics module 100 from the player (the electronics module 100 may be attached to an inner clothing layer) or forming a physical wired connection between the electronics module 100 and another device.

In an example user case, the electronics module 100 may communicate with the workstation over a one-to-one communication protocol such that only the workstation may receive, or decrypt sensor data received from the electronics module 100 under the communication protocol. The data may be exchanged between the electronics module 100 and the workstation following a pairing process. As an example, the communicator 103 may use a paired Bluetooth® communication protocol. The electronics module 100 may transmit the plurality of samples of historic sensor data over a one-to-many communication protocol. That is, the electronics module 100 may act as a beacon that broadcasts the historic sensor data such as over an unsecured wireless communication channel. Broadcasting the sensor data means that the historic sensor data can be exchanged more rapidly as pairing does not need to be established. As an example, the communicator 103 may act as a Bluetooth® beacon.

A pairing process may still be used to exchange the historic sensor data if desired. The electronics module 100 and the external device 200 may exchange information to facilitate the pairing process. The information may be exchanged over a magnetic induction-based communication protocol. The information exchanged may include an identifier for the electronics module 100 such as a MAC address or Bluetooth® address. The information exchanged may include a passkey, e.g. cryptographic information, to facilitate the pairing process. The pairing process may be an out-of-band (OOB) pairing process or similar. The information exchanged may comprise application information sent by the electronics module 100 to the external device such as over a magnetic induction-based communication protocol. The application information is useable by the external device 200 to start an application on the external device 200 or configure an application running on the external device 200. The application may be started on the external device 200 automatically (e.g. without user input). Alternatively, the application information may cause the external device 200 to prompt the user to start the application on the external device 200. The information may comprise a uniform resource identifier such as a uniform resource location to be accessed by the external device 200, or text to be displayed on the external device 200 for example.

The communicator 103 of FIG. 1 comprises a first communicator represented by first antenna 107 and a second communicator represented by second antenna 109.

The first antenna 107 in this example is used in magnetic induction-based communication with the external device 200. The magnetic induction-based communication may be a Near Field Communication (NFC) protocol.

The first antenna 107 in this example is useable in the determination of whether the external device 200 is in proximity with the electronics module 100. In particular, the external device 200 may also comprise magnetic induction-based communication circuitry which is energized to generate an electromagnetic field. The external device 200 being brought into proximity with the electronics module 200 causes a current to be induced in the first antenna 107. This induced current may be detectable by the processor 105 and may be used by the processor 105 to determine that the external device 200 is in proximity with the electronics module 100. The electronics module 100 may thus determine that an external device 200 is in proximity with the electronics module 100 may detecting the presence of an electromagnetic field.

In some examples, the communicator 103 may generate an interrupt in response to an electromagnetic field being detected. The communicator 103 may send the interrupt to the processor 105. The processor 105 determines that the external device 200 is in proximity with the electronics module 200 if the interrupt is received.

The second antenna 109 in this example is useable to transmit the historic sensor data. The second antenna 109 may use any wireless communication protocol. Particular examples include a Bluetooth® communication protocol or a WiFi® communication protocol.

Generally, the communicator 103 provides wireless communication capabilities for the wearable article and enables the wearable article to communicate via one or more wireless communication protocols such as used for communication over: a wireless wide area network (WWAN), a wireless metroarea network (WMAN), a wireless local area network (WLAN), a wireless personal area network (WPAN), Bluetooth® Low Energy, Bluetooth® Mesh, Bluetooth® 5, Thread, Zigbee, IEEE 802.15.4, Ant, Ant+ a near field communication (NFC), a Global Navigation Satellite System (GNSS), a cellular communication network, or any other electromagnetic RF communication protocol. The cellular communication network may be a fourth generation (4G) LTE, LTE Advanced (LTE-A), LTE Cat-M1, LTE Cat-M2, NB-IoT, fifth generation (5G), sixth generation (6G), and/or any other present or future developed cellular wireless network. A plurality of communicators may be provided for communicating over a combination of different communication protocols.

The electronics module 100 further comprises a sensor 111. The sensor 111 may comprise any form of sensor arrangement to monitor properties of a user wearing the electronics module 100 or an environment external to the user.

The sensor 111 may comprise a temperature sensor. The temperature sensor may be arranged to monitor a core body temperature, ambient temperature, or skin-surface temperature of the user. The temperature sensor may be a contact temperature sensor or a non-contact temperature sensor such as an infrared thermometer. Example contact temperature sensors include thermocouples and thermistors.

The electronics module 100 may comprise any other form of sensor such as to monitor the property of the user or the environment around the user. The sensor may comprise an altitude sensor, presence sensor, or air quality sensor. The presence sensor may for detecting a touch input from a user. The presence sensor may comprise one or more of a capacitive sensor, inductive sensor, and ultrasonic sensor. Other examples of sensor are provided throughout this specification. The sensor may be, for example, a humidity sensor arranged to monitor a hydration or sweat level of the user.

The sensor 111 may comprise a motion sensor 111. The memory 101 may be operable to store motion sensor data obtained by the motion sensor 111. The processor 105 may be operable to retrieve a plurality of samples of historic motion sensor data from the memory 101 and control the communicator 103 to wirelessly transmit the plurality of samples of historic motion sensor data.

In some examples, the motion sensor 111 and in particular the motion sensor data may be useable to determine whether the external device 200 is brought into communication with the electronics module 100. The motion sensor data may be used instead of the field detection performed by the first antenna 107 or in addition to or to supplement the field detect procedure. The motion sensor 111 in particular is arranged to detect motion imparted to the electronics module 100 as a result of the external device 200 being brought into proximity with the electronics module 100.

The present disclosure is not limited to using the motion sensor 111 or communicator 103 to detect the external device 200 approaching/contacting the electronics module 100. Instead, the electronics module 100 may comprise any form of input unit capable of detecting the external device 200, The input unit may comprise a user interface element such as a button. The button may be a mechanical push button. The user interface element is activated when the object (e.g. mobile device 200) is brought into proximity with the input unit. Simply, the user may tap their hand or mobile device 200 against the outside surface of the electronics module 100 or a further material covering the electronics module 100. The input unit may comprise a proximity sensor.

In some examples, the input unit 111 comprises a sensor 111 such as a proximity sensor or motion sensor.

In some examples, the memory 101 is operable to store sensor data obtained from a plurality of sensors of or in communication with the electronics module 100. The sensor data may comprise sensor data from other body worn devices that are in communication with the electronics module 100 but may not be physically connected to the electronics module 100. The electronics module 100 may act a hub for the other body worn devices and the data transmission of sensor data from the other devices may be coordinated by and/or implemented by the electronics module 100. The electronics module 100 may comprise a plurality of sensors 111. The wearable article that the electronics module 100 interfaces with may comprise a plurality of sensors or may comprise components of sensors such as electrodes. The sensor processing may be performed by the electronics module 100. That is, the electronics module 100 may receive measurement signals from the sensing components and uses these measurement signals to generate sensor data. This may comprise the electronics module 100 converting analog measurement signals into digital values.

The motion sensor 111 may comprise an inertial measurement unit 111. The inertial measurement unit 111 may comprise an accelerometer and optionally one or both of a gyroscope and a magnetometer. A gyroscope/magnetometer is not required in all examples, and instead only an accelerometer may be provided, or a gyroscope/magnetometer may be present but put into a low power state. A processor of the sensor 111 may perform processing tasks to classify different types of detected motion. The processor of the sensor 111 may, in particular, perform machine-learning functions so as to perform this classification. Performing the processing operations on the sensor 111 rather than the processor 105 is beneficial as it reduces power consumption and leaves the processor 105 free to perform other tasks. In addition, it allows for motion events to be detected even when the processor 105 is operating in a low power mode. The sensor 111 communicates with the processor 105 over a serial protocol such as the Serial Peripheral Interface (SPI), Inter-Integrated Circuit (I2C), Controller Area Network (CAN), and Recommended Standard 232 (RS-232). Other serial protocols are within the scope of the present disclosure.

It may be desirable to only transmit historic sensor for a subset of the sensors to the external device 200. The subset of the sensors may be sensors that record sensor data that is the most relevant for determining a medical condition of the user. For example, the electronics module 100 may obtain a plurality of sensor data such as heart rate data, temperature data, and motion data. Only the motion data may be required to be exchanged during the rapid data transfer process according to the present disclosure such as for the purpose of determining whether the user is likely to have suffered a concussion. In this way, the processor 105 may only obtain and transmit the historic motion sensor data from the memory 101. This enables the medical staff member to quickly determine whether the user is likely to have suffered a concussion.

In some examples, in response to detecting the external device 200 being in proximity with the electronics module 100, the processor 105 controls the communicator 103 to send an identifier for the electronics module 100 to the external device 200. The identifier may be sent via magnetic induction-based communication using the first antenna 107. The identifier may be or may indicate a communication address that will be used by the communicator 103 to transmit the historic sensor data. The external device 200 may then listen out for transmissions from that communication address.

In some examples, the external device 200 when brought into proximity with the electronics module 100 is arranged to send a request for historic sensor data to the electronics module 100. The request may be sent in response to the external device 200 receiving the identifier or other information from the electronics module 100. The processor 105 is operable to control the communicator 103 to wirelessly transmit the plurality of samples of historic sensor data in response to receiving the request. The request may be received over the magnetic induction-based proximity-communication protocol.

In some examples, the request comprises authorisation information for the external device 200. The authorisation information identifies whether the external device 200 is authorised to receive historic sensor data from the electronics module 100. The authorisation information may comprise a passkey. The processor 105 is arranged to determine from the authorisation information whether the external device 200 is authorised to access the sensor data. In response to determining that the external device 200 is authorised, the processor 105 is operable to control the communicator 103 to wireless transmit the plurality of samples of historic sensor data.

The electronics module 100 further comprises a power source 113. The power source 113 is coupled to the processor 105 and is arranged to supply power to the processor 105. The power source 113 may comprise a plurality of power sources. The power source 113 may be a battery. The battery may be a rechargeable battery. The battery may be a rechargeable battery adapted to be charged wirelessly such as by inductive charging. The power source 113 may comprise an energy harvesting device. The energy harvesting device may be configured to generate electric power signals in response to kinetic events such as kinetic events performed by a wearer of the wearable article. The kinetic event could include walking, running, exercising or respiration of the wearer. The energy harvesting material may comprise a piezoelectric material which generates electricity in response to mechanical deformation of the converter. The energy harvesting device may harvest energy from body heat of a wearer of the wearable article. The energy harvesting device may be a thermoelectric energy harvesting device. The power source may be a super capacitor, or an energy cell.

The electronics module 100 further comprises an interface 115. The interface 115 is arranged to communicatively couple with a sensing component of a wearable article so as to receive a signal from the sensing component or may directly interface with a skin surface of the wearer to receive signals therefrom. The interface 115 may form a conductive coupling or a wireless (e.g. inductive) communication coupling with the electronics components of the wearable article. The interface 115 may comprise the contact pads.

The electronics module 100 may comprise a Universal Integrated Circuit Card (UICC) that enables the electronics module 100 to access services provided by a mobile network operator (MNO) or virtual mobile network operator (VMNO). The UICC may include at least a read-only memory (ROM) configured to store an MNO/VMNO profile that the wearable article can utilize to register and interact with an MNO/VMNO. The UICC may be in the form of a Subscriber Identity Module (SIM) card. The electronics module 100 may have a receiving section arranged to receive the SIM card. In other examples, the UICC is embedded directly into a controller of the electronics module 100. That is, the UICC may be an electronic/embedded UICC (eUICC). A eUICC is beneficial as it removes the need to store a number of MNO profiles, i.e. electronic Subscriber Identity Modules (eSIMs). Moreover, eSIMs can be remotely provisioned to electronics modules 100. The electronics modules 100 may comprise a secure element that represents an embedded Universal Integrated Circuit Card (eUICC).

The plurality of samples of historic sensor data may cover any time period as desired by the skilled person. Generally, factors at the size of the memory and the desired data transmission time will affect how many samples are exchanged.

The present disclosure is not limited to triggering the transmission of historic sensor data in response to the external device 200 approaching the electronics module 100. In addition, or separately, the electronics module 100 may unilaterally determine to transmit historic sensor data. The electronics module 100 may determine to transmit historic sensor data by determining whether an abnormal condition is present in sensor data obtained from the sensor.

The abnormal condition may indicate that a user of the electronics module 100 has undergone a medical emergency.

The abnormal condition may be determined if sensor data indicates that one or more properties of the user are outside of an expected range. For example, the user's heart rate, core body temperature, hydration level, motion state or a combination thereof may be outside of an expected range. Outside of the expected range includes the values being unexpectedly high or unexpected low.

The electronics module 100 may detect that the user has fallen and subsequently remained stationary. This may trigger the electronics module 100 to transmit the historic sensor data.

The electronics module 100 may detect that the user has experienced an unexpectedly high acceleration and/or deceleration indicative of a collision. This may trigger the electronics module 100 to transmit the historic sensor data.

Other examples of abnormal conditions are within the scope of the present disclosure.

In some examples, in response to the electronics module 100 determining to transmit historic sensor data, the electronics module 100 may send a request to other electronics modules to also transmit their historic sensor data. For example, in response to the electronics module 100 detecting an external device 200 in proximity with the electronics module 100, the electronics module 100 may transmit a request to other electronics modules to transmit their historic sensor data. For example, in response to the electronics module 100 detecting that an abnormal condition is present in sensor data obtained from the sensor, the electronics module 100 may transmit a request to other electronics modules to transmit their historic sensor data. The request may be broadcast by the electronics module 100 such that any electronics module within the vicinity of the electronics module 100 may receive the request message and transmit their historic sensor data. The other electronics modules may be worn by other users.

For example, players in a football match may all be wearing an electronics module. If a first player is struck down and the medic triggers the electronics module of the first player to perform a data dump, the communicator of the electronics module (e.g. a Bluetooth Low Energy radio) of the first player will broadcast a message to other electronics module in the area to also perform a data dump. Advantageously, this means that any other players who collided with the first player will also be triggered to transmit their historic sensor data. Given that medical attention may be priorities on the more harmed player, the medic with their user clearance may not have time to manually scan the other players to obtain their historic sensor data. The present disclosure provides a mechanism for providing historic sensor data from a number of users to the medic following a single action performed by the medic. An electronics module (e.g. the electronics module of the first player) or the device of the medic could perform a scan to collect the other user's data. Again, the benefits of this approach are not limited to monitoring sports events, advantages can be achieved in other applications such as industrial or workplace settings.

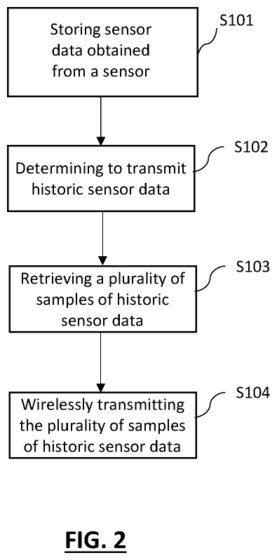

Referring to FIG. 2, there is shown an example method of controlling the electronics module 100 to transmit sensor data.

Step S101 of the method comprises storing, by the electronics module, sensor data obtained from a sensor of or in communication with the electronics module. The sensor data is stored in a memory of the electronics module.

Step S102 of the method comprises determining, by the electronics module, to transmit historic sensor data. The determining may comprise determining that an external device has been brought into proximity with the electronics module. The determining may comprise determining that an abnormal condition is present in sensor data obtained from the sensor. The determining may comprise determining that a request for historic sensor data has been received by the electronics module.

Step S103 comprises in response to determining to transmit historic sensor data: retrieving a plurality of samples of historic sensor data from a memory.

Step S104 comprises wirelessly transmitting the plurality of samples of historic sensor data.

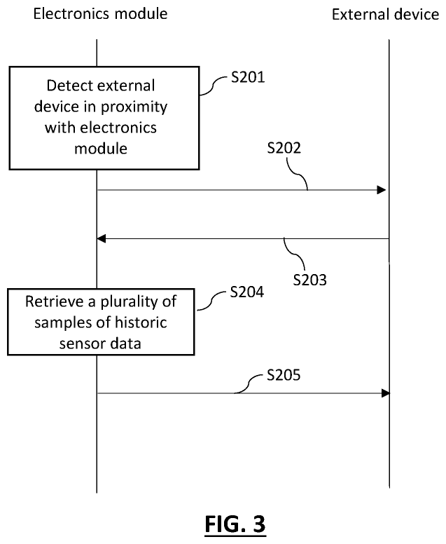

Referring to FIG. 3, there is shown a swim-lane flow diagram for an example method according to aspects of the present disclosure. The method is performed by the electronics module 100 and external device 200 in cooperation.

Step S201 comprises the electronics module 100 detecting that an external device is in proximity with the electronics module 100.

Step S202 comprises the electronics module 100 transmitting an identifier for the electronics module to the external device.

Step S203 comprises the electronics module 100 receiving a request for historic sensor data from the external device 200.

Step S204 comprises the electronics module 100 retrieving a plurality of samples of historic sensor data from a memory.

Step S205 comprises the electronics module 100 wirelessly transmitting the plurality of samples of historic sensor data. The plurality of samples of historic sensor data are received by the external device 200.

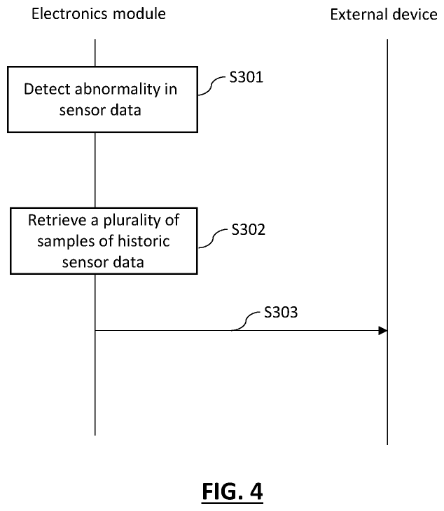

Referring to FIG. 4, there is shown a swim-lane flow diagram for an example method according to aspects of the present disclosure.

Step S301 comprises the electronics module detecting that an abnormality is present in the sensor data.

Step S302 comprises the electronics module 100 retrieving a plurality of samples of historic sensor data from a memory.

Step S303 comprises the electronics module 100 wirelessly transmitting the plurality of samples of historic sensor data. The plurality of samples of historic sensor data are received by the external device 200.

Referring to FIG. 5, there is shown an example system 1 according to aspects of the present disclosure. The system 1 comprises a wearable assembly 10 and an external device 200 in the form of a mobile device 200. The wearable assembly 10 comprises the electronics module 100 and a garment 300. The garment 300 is worn by a user 400. The electronics module 100 is attached to the garment 300. The electronics module 100 is shown positioned on a textile layer 301 of the garment 300 in FIG. 5. The electronics module 100 may be positioned within a pocket or similar mounting arrangement of the garment 300.

The electronics module 100 may be the electronics module 100 referred to above in relation to FIGS. 1 to 4.

The electronics module 100 is removable from the garment 300. The mechanical coupling of the electronic module 100 to the garment 300 may be provided by a mechanical interface such as a clip, a plug and socket arrangement, pocket etc. The mechanical interface may be referred to as an electronics module holder of the garment 300.

Beneficially, the removable electronic module 100 may contain all of the components required for data transmission and processing such that the garment 300 only comprises the sensor components and communication pathways. In this way, manufacture of the garment 300 may be simplified. In addition, it may be easier to clean a garment 300 which has fewer electronic components attached thereto or incorporated therein. Furthermore, the removable electronic module 100 may be easier to maintain and/or troubleshoot than embedded electronics. The electronic module 100 may comprise flexible electronics such as a flexible printed circuit (FPC). The electronic module 100 may be configured to be electrically coupled to the garment 300.

It may be desirable to avoid direct contact of the electronic module 100 with the wearer's skin while the garment 300 is being worn. It may be desirable to avoid the electronic module 100 coming into contact with sweat or moisture on the wearer's skin or other sources of moisture such as from rain or a shower. It may further be desirable to provide an electronics module holder such as a pocket in the garment to contain the electronic module 100 in order to prevent chafing or rubbing and thereby improve comfort for the wearer. The pocket may be provided with a waterproof lining in order to prevent the electronic module 100 from coming into contact with moisture.

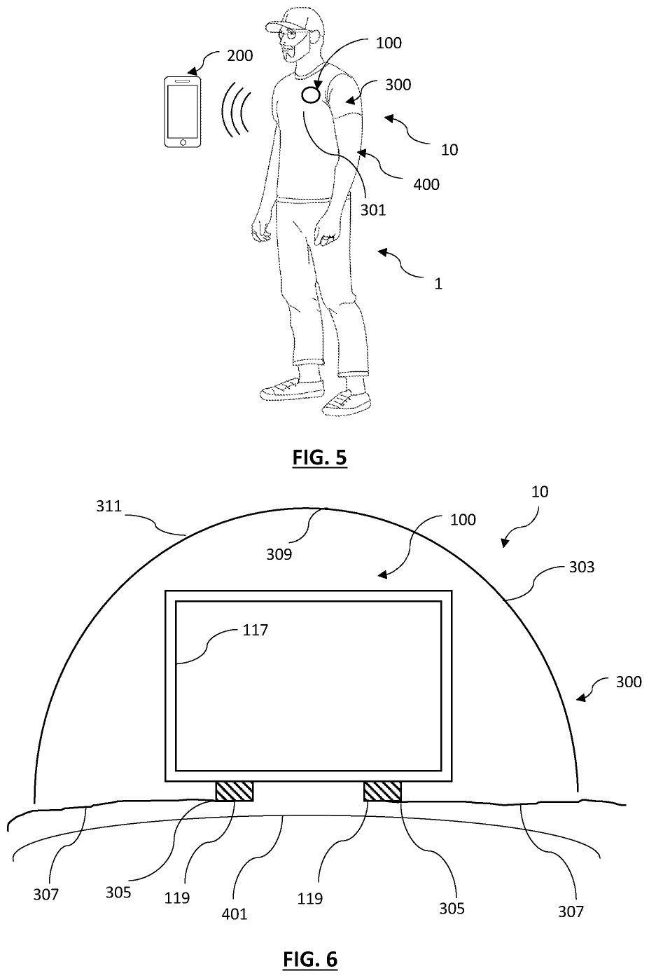

Referring to FIG. 6, there is shown a sectional view of assembly 10 comprising a garment 300 and the electronics module 100 disposed within an electronics module holder 303 of the garment 300. The garment 300 is being worn by a user and is proximate to the skin surface 401 of the user.

The electronics module holder 303 in this example is an elasticated pocket 303 positioned on the outside surface of the garment 300. In other examples, the electronics module holder 303 may be provided within the garment 300 such as in the form of an inner pocket.

The pocket 303 allows the user to position the electronics module 100 in the pocket 303 and remove it therefrom. The pocket 303 applies a compressive force to help hold the electronics module 100 in a generally fixed position within the pocket 303. This is not required in all examples as gripping surfaces of the electronics module 100 and/or the garment 300/pocket 303 may be sufficient for limiting relative movement between the electronics module 100 and the garment 300. Additionally, or separately, the electronics module 100 and the garment 300 may comprise magnetic elements to help hold the electronics module 100 in a fixed position relative to the garment 300. The housing of the electronics module 100 may be constructed to enable a magnet to be retained therein. In particular, a recess may be provided in an inner surface of a bottom enclosure of an electronics module 100 sized to retain a magnet.

The pocket 303 comprises a layer of material 303 which is bonded, stitched, otherwise attached to, or integrally formed with the garment 300. The pocket 303 has an inner surface 309 facing the electronics module 100. The pocket 303 has an outer surface 311 which can be considered as part of the outer surface 301, 311 of the garment 300.

The electronics module 100 comprises a housing 117 formed of a rigid material in this example. One or more electrical components are provided within the rigid housing 117 such as some or all of the electrical components shown in the schematic diagram of FIG. 1. The housing 117 may comprise a (rigid) polymeric material. The polymeric material may be a rigid plastic material. The rigid plastic material may be ABS or polycarbonate plastic but is not limited to these examples. The rigid plastic material may be glass reinforced. The rigid housing 117 may be injection moulded. The rigid housing 117 may be constructed using a twin-shot injection moulding approach.

The interface 115 (FIG. 1) of the electronics module 100 comprises a plurality (two in this example) of contact pads 119 provided on the outer surface of the housing 117. The contact pads 119 are formed from a flexible material, but this is not required in all examples. The contact pads 119 are spaced apart from one another on the bottom surface of the housing 117. “Rigid” will be understood as referring to a material which is stiffer and less able to bend than the contact pads 1119 formed of flexible material. The rigid housing 117 may still have some degree of flexibility but is less flexible than the flexible material of the contact pads 119.

The contact pads 119 comprise conductive material, and thus acts as conductive contact pads 119 for the electronics module 100. The flexible conductors 119 therefore provide the interface by which the electronics module 100 is able to receive signals from an external component such as the garment 300.

The contact pads 119 conductively connect with connection regions 305 of the garment 300. Each of the contact pads 119 is conductively connected with a different one of the connection regions 305. The connection regions 305 are not conductively connected together. The connection regions 305 enable the electronics module 100 to conductively connect to sensing components of the garment 300 via electrically conductive pathways 307. The sensing components may be one or more electrodes.

The electrically conductive pathways 307 and connection regions 305 may be formed from any form of conductive material such as conductive thread or wire. The conductive thread or wire may be woven or otherwise incorporated into a tape or fabric panel. The electrically conductive pathways 307 and connection regions 305 may be electrically conductive tracks or films. The electrically conductive pathways 307 and connection regions 305 may be conductive transfers. The conductive material may be formed from a fibre or yarn of the textile. This may mean that electrically conductive materials are incorporated into the fibre/yarn. The conductive material may be a conductive rubber.

The use of flexible conductors 119 is generally preferred as compared to rigid, metallic, conductors 119 as this means that hard pieces of conductive metallic material such as poppers or studs are not required to electrically connect the electronics module 100 to the garment 300. This not only improves the look and feel of the garment 300 but also reduces manufacturing costs as it means that hardware features such as additional eyelets and studs do not need to be incorporated into the garment 300 to provide the required connectivity. An additional problem with rigid metallic conductors is that their hard, abrasive, surfaces may rub against conductive elements such as conductive thread of the garment and cause the conductive thread to fray.

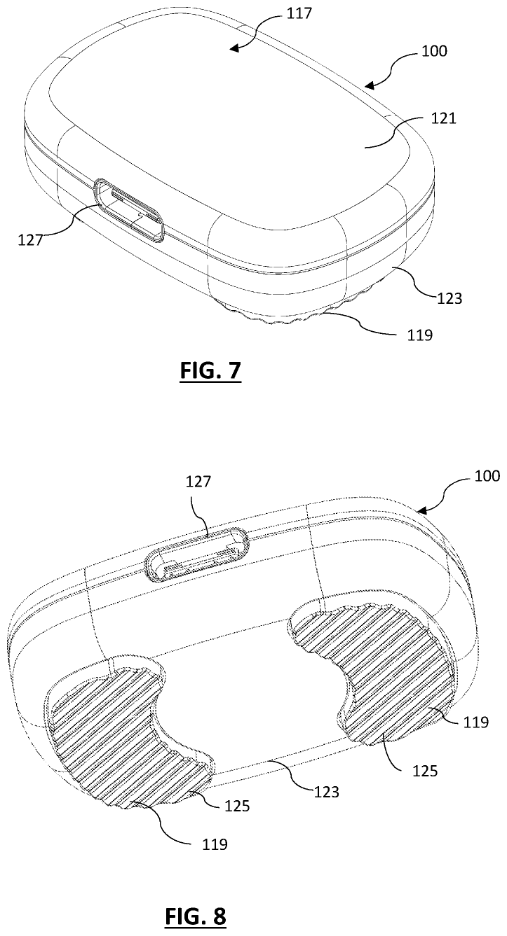

FIGS. 7 and 8 show an example electronics module 100 according to aspects of the present disclosure. The electronics module 100 comprises a rigid housing 117 and a plurality (two in this example) of contact pads 119 that are attached to an external surface of the rigid housing 117 and spaced apart from one another. The contact pads 119 in this example are constructed from a flexible material, and in particular a flexible conductive material. The contact pads 119 therefore form an outer layer of flexible material that covers a part of the rigid housing 117. Rigid contact pads 119 such as those made from a rigid metallic material are also within the scope of the present disclosure.

The rigid housing 117 comprises a top enclosure 121 and a bottom enclosure 123. The top and bottom enclosures 121 and 123 are snap fitted together. A sealant material such as bead of silicon may be applied to the lip of one or both of the top and bottom enclosures 121, 123 prior to joining them together so as to form a water-tight seal at the join between the top and bottom enclosure 121, 123. This may beneficially protect against water ingress into the electronics module 100. The use of a two or more enclosures which are coupled together such as the top enclosure 121 and the bottom enclosure 123 is not required in all examples of the present disclosure. A single piece housing such as one which is overmoulded over the components of the module 100 is also within the scope of the present disclosure. Alternatively, or additionally, the top enclosure 121 and the bottom enclosure 123 may be joined together by screws, sonic welding, glue or by any other means known to those skilled in the art.

The contact pads 119 are formed of two separate pieces of conductive elastomeric material 119 that form first and second flexible conductors 119. The conductive elastomeric material used in this example is a conductive silicone rubber material, but other forms of conductive elastomeric material may be used. Beneficially, elastomeric material such as conductive silicone rubber can have an attractive visual appearance and may easily be moulded or extruded to have branded or other visual elements.

The elastomeric material is made conductive by distributing a conductive material into the elastomeric material. Conductive particles such as carbon black and silica are commonly used to form conductive elastomeric materials, but the present disclosure is not limited to these examples. The contact pads 119 may also comprise a 2D electrically conductive material such as graphene or a mixture or composite of an elastomeric material and a 2D electrically conductive material.

The contact pads 119 define an external surface 125 that faces away from the bottom enclosure 123. The surface 125 is arranged to interface with an external component so as to couple signals between the external component and a controller of the electronics module. The external component may be a conductive region of the wearable article or a skin surface of the wearer amongst other examples. The external component is typically the connection regions 305 (FIG. 6) of the garment 300. The surface 125 is textured to provide additional grip when positioned on the garment 300 or the skin surface. The texture may be, for example, a ribbed or knurled texture. The elastomeric material 119 shown in the Figures has a ribbed texture. The contact pads 119 may be flat and are not required to have a textured surface.

The electronics module 100 further comprises a charging interface 127 for coupling the electronics module 100 to a further device so as to charge a battery of the electronics module 100 and/or transfer data between the electronics module 100 and the further device. The charging interface 127 is a USB-C interface.

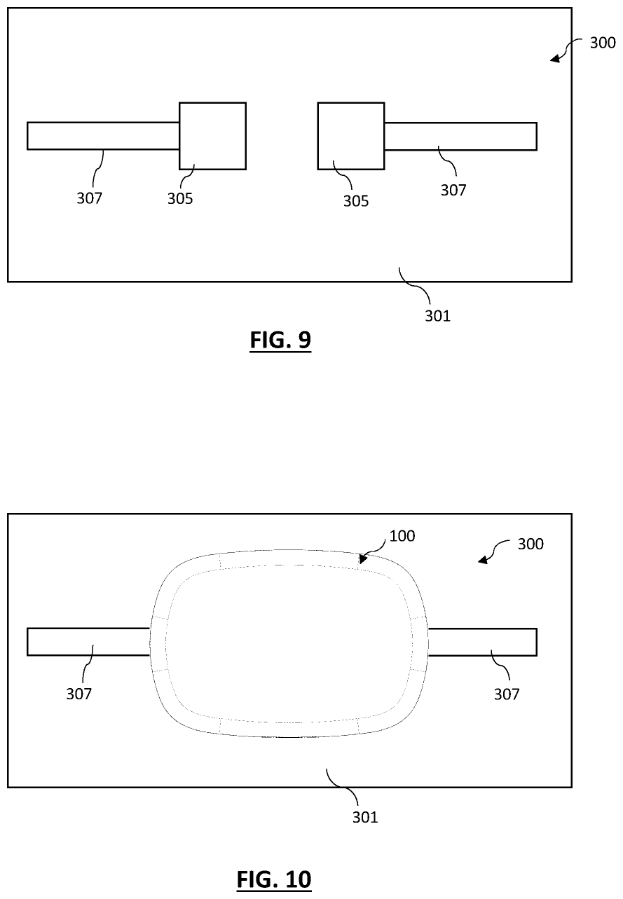

FIGS. 9 to 12 show how the electronics module 100 may be positioned on the garment 300 so that the interface elements 119 of the electronics module 100 are brought into communication with the connection regions 305 of the garment 300.

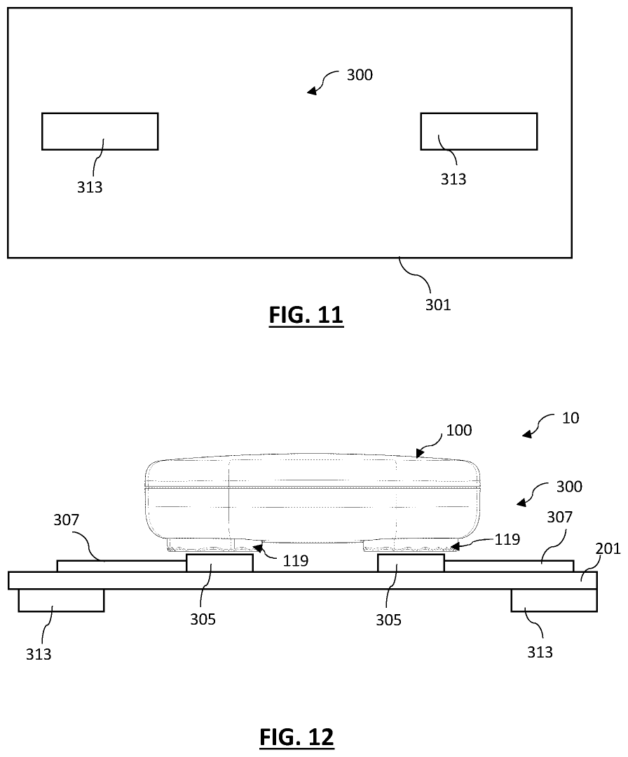

FIG. 9 shows the garment 300 in isolation. The garment 300 comprises a textile layer 301 on which the connection regions 305 and conductive pathways 307 are provided. FIG. 10 shows the electronics module 100 positioned on the textile layer 301. FIG. 11 shows the underside surface of the textile layer 301 on which the electrodes 313 are provided. FIG. 12 is a sectional view. The electronics module 100 is positioned on the textile layer 301 such that the interface elements 119 are brought into contact with the connection regions 305. In this way, the interface elements 119 are brought into communication with the electrodes 313 via the conductive pathways 307.

In summary, there is provided an electronics module for a wearable article. The electronics module 100 comprises a memory 101 operable to store sensor data obtained from a sensor of or in communication with the electronics module 100. A communicator 103 is operable to transmit sensor data. A processor 105 is operable to retrieve a plurality of historic sensor data from the memory 101, and control the communicator 103 to wirelessly transmit the plurality of samples of historic sensor data in response to the processor 105 determining to transmit historic sensor data. Determining to transmit historic sensor data comprises the processor 105 determining that an external device 200 has been brought into proximity with the electronics module 100 and/or comprises the processor 105 determining that an abnormal condition is present in sensor data obtained from the sensor and/or comprises the processor 105 determining that a request for historic sensor data has been received.

In the present disclosure, the electronics module may also be referred to as an electronics device or unit. These terms may be used interchangeably.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-25. (canceled)

26. An electronics module for a wearable article, the electronics module comprising:
a memory operable to store sensor data obtained from a sensor of or in communication with the electronics module;
a communicator comprising a first antenna and a second antenna;
a processor operable to retrieve a plurality of samples of historic sensor data from the memory, and control the second antenna to wirelessly transmit the plurality of samples of historic sensor data in response to the processor determining to transmit historic sensor data, wherein determining to transmit historic sensor data comprises the processor determining that an external device has been brought into proximity with the electronics module and that a request for historic sensor data has been received from the external device via the first antenna.

27. The electronics module according to claim 26, wherein the processor is operable to control the communicator to broadcast the plurality of samples of historic sensor data.

28. The electronics module according to claim 26, wherein the processor is operable to control the communicator to wirelessly pair with the external device and, once paired, transmit the plurality of samples of historic sensor data to the external device.

29. The electronics module according to claim 26, wherein the processor is operable to determine that an external device is brought into proximity with the electronics module as a result of a current being induced in the first antenna.

30. The electronics module according to claim 26, wherein the electronics module further comprises a motion sensor.

31. The electronics module according to claim 30, wherein the memory is operable to store motion sensor data obtained from the motion sensor, and wherein the processor is operable to retrieve a plurality of samples of historic motion sensor data from the memory, and control the communicator to wirelessly transmit the plurality of samples of historic motion sensor data.

32. The electronics module according to claim 31, wherein the motion sensor is arranged to detect motion imparted to the electronics module as a result of the external device being brought into proximity with the electronics module, and wherein the processor is operable to determine that the external device has been brought into proximity with the electronics module as a result of motion sensor data sensed by the motion sensor.

33. The electronics module according to claim 26, wherein the communicator is arranged to receive the request while the external device is in proximity with the electronics module.

34. The electronics module according to claim 26, wherein the request comprises authorisation information for the external device, wherein the processor is arranged to determine from the authorisation information whether the external device is authorised to access the sensor data, and wherein, in response to determining that the external device is authorised, the processor is operable to control the communicator to wirelessly transmit the plurality of samples of historic sensor data.

35. The electronics module according to claim 26, wherein the memory is operable to store sensor data obtained from a plurality of sensors of or in communication with the electronics module.

36. The electronics module according to claim 35, wherein the processor is operable to retrieve a plurality of samples of historic sensor data from the memory, the plurality of samples of historic sensor data comprising sensor data obtained from the plurality of sensors or a subset thereof.

37. The electronics module according to claim 26, wherein the plurality of samples of historic sensor data cover a time period of at least 0.5 seconds preceding the determination to transmit sensor data by the processor.

38. The electronics module according to claim 37, wherein the plurality of samples of historic sensor data cover a time period of at least 1 second preceding the determination to transmit sensor data by the processor.

39. The electronics module according to claim 38, wherein the plurality of samples of historic sensor data cover a time period of at least 5 seconds preceding the determination to transmit sensor data by the processor.

40. The electronics module according to claim 39, wherein the plurality of samples of historic sensor data cover a time period of at least 10 seconds preceding the determination to transmit sensor data by the processor.

41. The electronics module according to claim 26, wherein the plurality of samples of historic sensor data cover a time period that immediately precedes the determination to transmit sensor data by the processor.

42. The electronics module according to claim 26, wherein the processor is further operable to control the communicator to transmit a request for historic sensor data to a further electronics module.

43. The electronics module according to claim 42, wherein the communicator is operable to receive the historic sensor data from the further electronics module.

44. A system comprising the electronics module according to claim 26 and an external device, wherein the external device is arranged to receive the plurality of samples of historic sensor data from the electronics module.

45. A method of controlling an electronics module for a wearable article to transmit sensor data, the method comprises:
storing, by the electronics module, sensor data obtained from a sensor of or in communication with the electronics module;
determining, by the electronics module, to transmit historic sensor data, the determining comprising determining that an external device has been brought into proximity with the electronics module and that a request for historic sensor data has been received from the external device via a first antenna of the electronics module; and
in response to determining to transmit historic sensor data: retrieving, by the electronics module, a plurality of stored samples of historic sensor data, and wirelessly transmitting, by a second antenna of the electronics module, the plurality of samples of historic sensor data.
